(19) United States
(12) Patent Application Publication
(10) Pub. No.: US 2025/0326561 A1
(43) Pub. Date: Oct. 23, 2025

(54) SELF-EXPANDABLE INSULATING BOX LINER

(71) Applicant: Everest Manufacturing, Toledo, OH (US)

(72) Inventor: Robert M. Hadley, Swanton, OH (US)

(73) Assignee: Everest Manufacturing, Toledo, OH (US)

(21) Appl. No.: 19/181,801

(22) Filed: Apr. 17, 2025

Related U.S. Application Data
(60) Provisional application No. 63/635,475, filed on Apr. 17, 2024.

(51) Int. Cl. B65D 81/38; B31B 50/59; B31B 50/60; B31B 105/00; B31B 120/40

(52) U.S. Cl. CPC B65D 81/3823; B31B 50/59; B65D 81/3816; B31B 50/60; B31B 2105/0025; B31B 2120/407

(57) ABSTRACT

A self-expandable insulating box liner includes a first insulating panel assembly, a second insulating panel assembly, and a plurality of layers of an oxygen barrier film. Each of the first and second insulating panel assemblies includes an insulating panel portion sealed between two layers of the oxygen barrier film. Each of the insulating panel portions has a first, pre-compressed thickness. The insulating panel portions are compressed to a second, compressed thickness smaller than the first, pre-compressed thickness prior to being sealed between the two layers of the oxygen barrier film. When compressed and sealed, the insulating panel portions retain the second, compressed thickness. The insulating panel portions are movable from the second, compressed thickness to the first, pre-compressed thickness when one of the two layers of oxygen barrier film is punctured.

### CROSS-REFERENCE TO RELATED APPLICATIONS

This application claims the benefit of U.S. Provisional Application No. 63/635,475, filed Apr. 17, 2022, the disclosure of which is incorporated herein by reference.

### BACKGROUND OF THE INVENTION

This invention relates in general to an insulating box liner that is configured to be folded into a three-dimensional shape and fit into, line, and insulate a corrugated box. In particular, this invention relates to an improved structure for such an insulating box liner that is self-expandable.

With the ever-increasing volume of online orders for perishable goods, and other goods that must be kept below a certain temperature during shipping, there is a growing need to insulate corrugated shipping boxes.

Often, perishable goods are shipped in containers that contain gel or ice packs to help maintain a required temperature. The containers themselves may also contain bags or liners to help keep the items cool during shipping. Gel and ice packs, as well as specially-formed liners for shipping containers, require additional materials and manufacturing steps, and can add to the overall cost of shipping. For example, some known liners may require the assembly of multiple pieces to be placed in the shipping container.

Metalized bubble box liners are also known, and are similar in that they are typically formed as a one-piece box liner, but differ in that they are typically configured as a bag with a bottom-gusset that forms to fit the shipping box. These metalized bubble box liners tend to offer a much lower level of thermal performance.

Molded expanded polystyrene (EPS) coolers are another known option for insulating a corrugated box. However, EPS coolers are not collapsable, may not be efficiently palletized, and are therefore not cost effective to ship. Additionally, in some areas of the United States, environmental regulations require the phase out EPS in packaging applications.

There are various known approaches for insulating a corrugated box. U.S. Patent Pub. No. 2012/0223808A1 discloses a one-piece insulating box liner that uses urethane foam. However, the insulating liner consists of a contour-cut piece of urethane foam that is placed inside of a foil bag with a zipper or zip-top seal and a handle.

Another example of an insulating box liner is disclosed in U.S. Pat. No. 10,322,843. The box liner disclosed therein is formed from a lightweight, thermal insulation material, but is not self-expandable.

Thus, it would be desirable to provide an improved box liner to insulate a corrugated box, wherein the box-liner is compact, self-expandable, and less costly to ship than conventional insulating box liners.

### SUMMARY OF THE INVENTION

This invention relates in general to an insulating box liner that is self-expandable and configured to be folded into a three-dimensional shape and fit into, line, and insulate a corrugated box. An self-expandable insulating box liner includes a first insulating panel assembly, a second insulating panel assembly, and a plurality of layers of an oxygen barrier film. Each of the first and second insulating panel assemblies includes an insulating panel portion sealed between two layers of the oxygen barrier film. Each of the insulating panel portions has a first, pre-compressed thickness. The insulating panel portions are compressed to a second, compressed thickness smaller than the first, pre-compressed thickness prior to being sealed between the two layers of the oxygen barrier film. When compressed and sealed, the insulating panel portions retain the second, compressed thickness. The insulating panel portions are movable from the second, compressed thickness to the first, pre-compressed thickness when one of the two layers of oxygen barrier film is punctured.

Various aspects of this invention will become apparent to those skilled in the art from the following detailed description of the preferred embodiment, when read in view of the accompanying drawings.

### BRIEF DESCRIPTION OF THE DRAWINGS

FIG. 1 is a top plan view of a first insulating panel portion in accordance with this invention.

FIG. 2 is a side elevational view of the first insulating panel portion illustrated in FIG. 1 showing the first insulating panel portion having the first, pre-compressed thickness.

FIG. 3 is a top plan view of the first insulating panel assembly in accordance with this invention.

FIG. 4 is a side elevational view of the first insulating panel assembly illustrated in FIG. 3 showing the first insulating panel assembly having the second, compressed thickness.

FIG. 5 is a top plan view of a second insulating panel portion in accordance with this invention.

FIG. 6 is a side elevational view of the second insulating panel portion illustrated in FIG. 5 showing the first insulating panel portion having the first, pre-compressed thickness.

FIG. 7 is a top plan view of the second insulating panel assembly in accordance with this invention.

FIG. 8 is a side elevational view of the second insulating panel assembly illustrated in FIG. 7 showing the second insulating panel assembly having the second, compressed thickness.

FIG. 9 is a top plan view of the self-expandable insulating box liner in accordance with this invention.

FIG. 10 is a perspective view of the self-expandable insulating box liner illustrated in FIG. 9 showing the self-expandable insulating box liner having the first, pre-compressed thickness and folded into a box shape with the top of the box open.

FIG. 11 is a perspective view of the self-expandable insulating box liner illustrated in FIGS. 9 and 10 showing the self-expandable insulating box liner folded into a box shape with the top of the box closed.

FIG. 12 is a perspective view of the second insulating panel assembly illustrated in FIG. 7 showing the second insulating panel assembly having the first, pre-compressed thickness and folded to define the three side panels of the self-expandable insulating box liner.

FIG. 13 is a perspective view of the first insulating panel assembly illustrated in FIG. 3 showing the first insulating panel assembly having the first, pre-compressed thickness and folded to define the bottom panel, the side panel, and the top panel of the self-expandable insulating box liner.

FIG. 14 is a perspective view of the second insulating panel assembly shown in FIG. 12 and the first insulating panel assembly shown in FIG. 13 being assembled together to define the self-expandable insulating box liner.

FIG. 15 is a perspective view of the self-expandable insulating box liner illustrated in FIG. 14 showing the self-expandable insulating box liner folded into a box shape with the top of the box closed.

### DETAILED DESCRIPTION OF THE PREFERRED EMBODIMENT

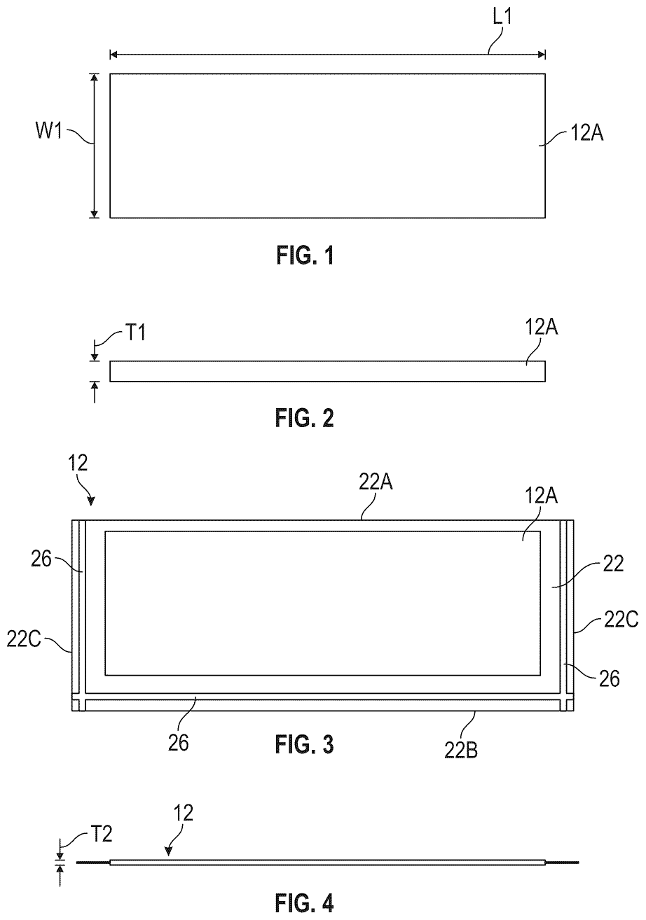

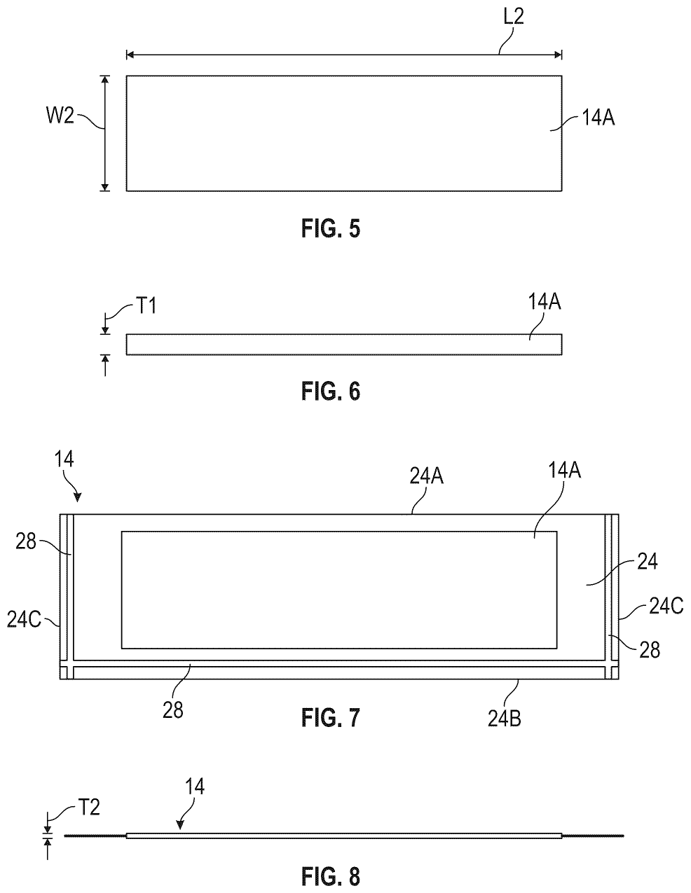

Referring now to the drawings, there is illustrated in FIGS. 1 through 9 a basic structure of a self-expandable insulating box liner 10 in accordance with this invention. The illustrated self-expandable insulating box liner 10 is configured to be folded into a three-dimensional shape and fit into, line, and insulate a corrugated box (not shown).

The illustrated self-expandable insulating box liner 10 includes a first insulating panel assembly 12 attached to a second insulating panel assembly 14 by means described below. As best shown in FIGS. 10 and 11, the first insulating panel assembly 12 defines a bottom panel 16, a side panel 18, and a top panel 20, and the second insulating panel assembly 14 defines three additional side panels 18.

Referring now to FIGS. 1 through 8, the first insulating panel assembly 12 includes a first insulating panel portion 12A having two opposing planar faces and is covered on both planar faces with an oxygen barrier film 22. Similarly, the second insulating panel assembly 14 includes a second insulating panel portion 14A having two opposing planar faces and is covered on both planar faces with an oxygen barrier film 24. The first insulating panel portion 12A has a width W1 and a length L1. Similarly, the second insulating panel portion 14A has a width W2 and a length L2.

The first and second insulating panel portions 12A and 14A, respectively, may be formed from any desired foam material capable of being compressed and subsequently expanding to its original thickness, such as flexible polyurethane foam. Alternatively, other foam material, such as foam material that may be compressed, retained in a compressed state, and returned to a pre-compressed thickness, may be used. In the illustrated embodiments, the first and second insulating panel portions 12A and 14A are formed from flexible polyurethane foam having a first, pre-compressed thickness T1 of about 1.375 in. The first and second insulating panel portions 12A and 14A are self-expandable.

As used herein, self-expandable is defined as a material having a first, pre-compressed thickness that is capable of being compressed to a second, compressed thickness smaller than the first, pre-compressed thickness, stored in the compressed state for a prolonged period, and subsequently expanded to the first, pre-compressed thickness when the means of compression are removed.

Specifically, the first and second insulating panel portions 12A and 14A are capable of being compressed, as will be described below, to a second, compressed thickness T2 of about 0.3125 in, stored in the compressed state for a prolonged period, and subsequently expanded to the first, pre-compressed thickness T1 of about 1.375 in when the means of compression are removed.

The oxygen barrier film 22 and 24 may be formed from any desired oxygen barrier film including, but not limited to, low density polyethylene. Additionally, any other film that is air impermeable, or resistant to air flow therethrough, may be used.

As best shown in FIG. 3, the oxygen barrier film 22 may be formed as a single sheet of film that is folded over the first insulating panel portion 12A such that the oxygen barrier film 22 covers each of the planar faces of the first insulating panel portion 12A. The folded oxygen barrier film 22 defines a first or folded longitudinal edge 22A, a second or open longitudinal edge 22B, and two opposing open transverse edges 22C. The oxygen barrier film 22 is positioned over the first insulating panel portion 12A such that the second longitudinal edge 22B and the transverse edges 22C of the oxygen barrier film 22 extend outwardly beyond the transverse edges and one longitudinal edge of the first insulating panel portion 12A a distance of about 1.0 in to about 1.25 in. The first longitudinal edge 22A of the oxygen barrier film 22 similarly extends beyond the longitudinal edge of the first insulating panel portion 12A a distance within about 0.5 in to about 1.0 in.

The outer peripheral edges 22B and 22C of the oxygen barrier film 22 may be sealed, such as with a heat seal or with pressure sensitive adhesive, such that a sealed portion 26 of the peripheral edges 22B and 22C of the oxygen barrier film 22 has a width of about 0.375 in.

Similarly, and as best shown in FIG. 7, the oxygen barrier film 24 may be formed as a single sheet of film that is folded over the second insulating panel portion 14A such that the oxygen barrier film 24 covers each of the planar faces of the second insulating panel portion 14A. The folded oxygen barrier film 24 defines a first or folded longitudinal edge 24A, a second or open longitudinal edge 24B, and two opposing open transverse edges 24C. The oxygen barrier film 24 is positioned over the second insulating panel portion 14A such that the second longitudinal edge 24B and the transverse edges 24C of the oxygen barrier film 24 extend outwardly beyond the transverse edges and one longitudinal edge of the second insulating panel portion 14A a distance of about 1.0 in to about 1.25 in. The first longitudinal edge 24A of the oxygen barrier film 24 similarly extends beyond the longitudinal edge of the second insulating panel portion 14A a distance within about 0.5 in to about 1.0 in.

The outer peripheral edges 24B and 24C of the oxygen barrier film 24 may be sealed, such as with a heat seal or with pressure sensitive adhesive, such that a sealed portion 28 of the peripheral edges 24B and 24C of the oxygen barrier film 24 has a width of about 0.375 in.

Thus, during assembly, the first and second insulating panel portions 12A and 14A are formed and/or cut to desired lengths L1 and L2 and widths W1 and W2 from the desired foam material, such as flexible polyurethane foam having the first, pre-compressed thickness T1 of about 1.375 in. The first insulating panel portion 12A is wrapped by the oxygen barrier film 22, as shown in FIG. 3, compressed, such as with a press, to the second, compressed thickness T2 of about 0.3125 in, and sealed with a heat seal or with pressure sensitive adhesive, as shown at 26. It will be understood that once sealed, the first insulating panel portion 12A retains the second, compressed thickness T2 of about 0.3125 in. Similarly, the second insulating panel portion 14A is wrapped by the oxygen barrier film 24, as shown in FIG. 7, compressed, such as with a press, to the second, compressed thickness T2 of about 0.3125 in, and sealed with a heat seal or with pressure sensitive adhesive, as shown at 28. It will be understood that once sealed, the first insulating panel portion 14A retains the second, compressed thickness T2 of about 0.3125 in.

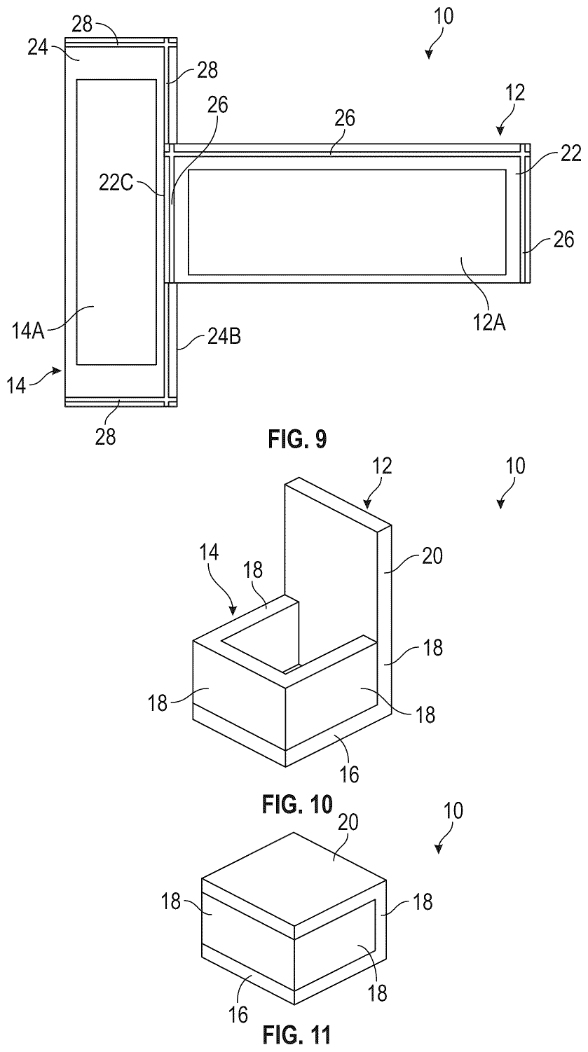

Once sealed with the oxygen barrier film 22 and 24, the first insulating panel assembly 12 is aligned with the second insulating panel assembly 14, such that a transverse edge 22C of the oxygen barrier film 22 overlaps the second longitudinal edge 24B of the oxygen barrier film 24, as shown in FIG. 9. The oxygen barrier film 22 and 24 of the first and second insulating panels 12 and 14, respectively, are attached together, such as with pressure sensitive adhesive, or by heat sealing, thus defining the self-expandable insulating box liner 10 having a T-shape.

The first and second insulating panel portions 12A and 14A may be cut or otherwise formed having lengths L1 and L2 and widths W1 and W2 slightly longer than a length and width of the inside of the corrugated box within which the self-expandable insulating box liner 10 will be placed. For example, each of the lengths L1 and L2, and the widths W1 and W2 may be within about 0.0 in and about 0.25 in longer than the respective lengths and widths of the inside of the corrugated box within which the insulating box liner 10 will be placed. This additional length and width of the first and second insulating panel portions 12A and 14A allows the insulating box liner 10 to fit snuggly within the corrugated box and be retained therein.

When a user desires to use the insulating box liner 10 to line a box, such as a corrugated box, the user first punctures the oxygen barrier film 22 of the first insulating panel assembly 12 and the oxygen barrier film 24 of the second insulating panel assembly 14, such as with a pin, a knife, or a similar sharp tool. Air is therefore allowed to enter through the puncture in the oxygen barrier film 22 and the first insulating panel portion 12A and the second insulating panel portion 14A then each expand to the first, pre-compressed thicknesses T1 of about 1.375 in.

As best shown in FIGS. 9 through 11, the first insulating panel assembly 12 may be folded to define the bottom panel 16, the side panel 18, and the top panel 20 of the insulating box liner 10, and the second insulating panel assembly 14 may be folded to define three additional side panels 18 of the insulating box liner 10.

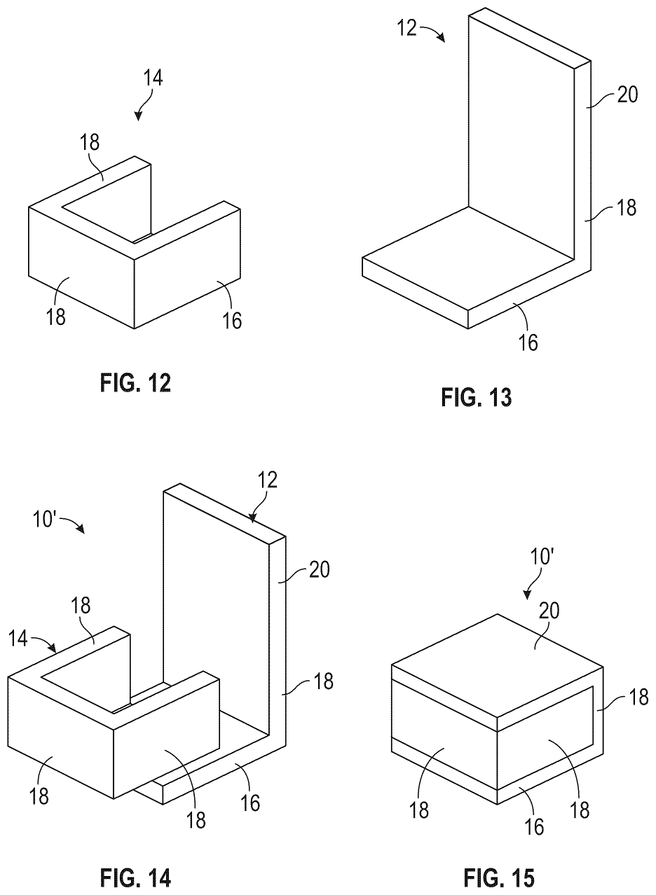

Alternatively, the first and second insulating panel assemblies 12 and 14 may be formed, but not attached together, such that the first and second insulating panel assemblies 12 and 14 may be installed into a corrugated box as separate components. As with the insulating box liner 10, the user may then puncture the oxygen barrier film 22 of the first insulating panel assembly 12 and the oxygen barrier film 24 of the second insulating panel assembly 14, such as with a pin, a knife, or a similar sharp tool, allowing the first and second insulating panel portions 12A and 14A to expand to the first, pre-compressed thicknesses T1 of about 1.375 in. As best shown in FIGS. 12 through 14, the first insulating panel assembly 12 may be folded to define the bottom panel 16, the side panel 18, and the top panel 20 of the insulating box liner 10′, and the second insulating panel assembly 14 may be folded to define three additional side panels 18 of the insulating box liner 10′.

Advantageously, the compressed insulating box liners 10 and 10′ have the second, compressed thicknesses T2 that are about 20 to about 25 percent of the first, pre-compressed thicknesses T1. Accordingly, a larger number of the compressed insulating box liners 10 and 10′ may be loaded in a shipping container or on a pallet relative to the pre-compressed, and thicker, insulating box liners 10 and 10′, thus conserving warehouse space and reducing shipping costs.

In an additional embodiment, the first and second insulating panel portions 12A and 14A may be formed from material that is not compressible but that is environmentally friendly. For example, each of the first and second insulating panel portions 12A and 14A may be formed from recyclable material including, but not limited to, recycled polyethylene terephthalate (PET), jute, and recycled cotton. Although not compressible, the first and second insulating panel portions 12A and 14A formed from recyclable material may be wrapped and sealed with the oxygen barrier film 22 and 24, respectively, and the first and second insulating panel portions 12A and 14A may be attached as described above to form an insulating box liner (not shown), similar to the insulating box liner 10 shown in FIG. 9.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A self-expandable insulating box liner comprising:
a first insulating panel assembly;
a second insulating panel assembly; and
a plurality of layers of an oxygen barrier film;
wherein each of the first and second insulating panel assemblies includes an insulating panel portion sealed between two layers of the oxygen barrier film;
wherein each of the insulating panel portions has a first pre-compressed thickness;
wherein the insulating panel portions are compressed to a second, compressed thickness smaller than the first, pre-compressed thickness prior to being sealed between the two layers of the oxygen barrier film;
wherein when compressed and sealed, the insulating panel portions retain the second, compressed thickness; and
wherein the insulating panel portions are movable from the second, compressed thickness to the first, pre-compressed thickness when one of the two layers of oxygen barrier film is punctured.

2. The self-expandable insulating box liner according to claim 1, wherein the insulating panels are formed from flexible polyurethane foam.

3. The self-expandable insulating box liner according to claim 1, wherein the oxygen barrier film is formed from low density polyethylene.

4. The self-expandable insulating box liner according to claim 1, wherein each of the first and second insulating panel assemblies are configured to be folded into a three-dimensional shape and fit into, line, and insulate a box.

5. The self-expandable insulating box liner according to claim 1, wherein the insulating panel portions are sealed between the two layers of the oxygen barrier film by one of pressure sensitive adhesive and heat sealing.

6. The self-expandable insulating box liner according to claim 1, wherein the oxygen barrier film of the first and second insulating panels are attached together to define a one-piece insulating box liner having a T-shape.

7. The self-expandable insulating box liner according to claim 6, wherein a transverse edge of the first insulating panel assembly overlaps a longitudinal edge of the second insulating panel assembly.

8. The self-expandable insulating box liner according to claim 1, wherein the second, compressed thickness is about 20 to about 25 percent of the first, pre-compressed thickness.

9. The self-expandable insulating box liner according to claim 1, wherein the insulating panel portions are rectangular.

10. The self-expandable insulating box liner according to claim 1, wherein the first insulating panel assembly is configured to be folded to define a bottom panel, a side panel, and a top panel of the insulating box liner; and
wherein the second insulating panel assembly is configured to be folded to define three side panels of the insulating box liner.

11. A method of forming a self-expandable insulating box liner comprising:
positioning a first insulating panel portion between two layers of an oxygen barrier film;
positioning a second insulating panel portion between two layers of the oxygen barrier film;
wherein each of the first and second insulating panel portions have a first pre-compressed thickness;
compressing the first insulating panel portion and sealing the peripheral edges of the two layers of the oxygen barrier film to define a first insulating panel assembly; and
compressing the second insulating panel portion and sealing the peripheral edges of the two layers of the oxygen barrier film to define a second insulating panel assembly;
wherein the first and second insulating panel portions are compressed to a second, compressed thickness smaller than the first, pre-compressed thickness;
wherein when compressed and sealed, the first and second insulating panel portions retain the second, compressed thickness; and
wherein the first and second insulating panel portions are movable from the second, compressed thickness to the first, pre-compressed thickness when one of the two layers of oxygen barrier film is punctured.

12. The method according to claim 11, further including folding each of the first and second insulating panel assemblies into a three-dimensional shape, such that the folded three-dimensional shape fits into, lines, and insulates a box.

13. The method according to claim 12, further including folding the first insulating panel assembly to define a bottom panel, a side panel, and a top panel of the insulating box liner; and
folding the second insulating panel assembly to define three side panels of the insulating box liner.

14. The method according to claim 11, wherein the insulating panels are formed from flexible polyurethane foam.

15. The method according to claim 11, wherein the oxygen barrier film is formed from low density polyethylene.

16. The method according to claim 11, further including sealing the oxygen barrier film of the first and second insulating panel assemblies by one of pressure sensitive adhesive and heat sealing.

17. The method according to claim 11, further including attaching the oxygen barrier film of the first and second insulating panels together to define a one-piece insulating box liner having a T-shape.

18. The method according to claim 17, further including overlapping a transverse edge of the first insulating panel assembly with a longitudinal edge of the second insulating panel assembly prior to attaching the oxygen barrier film of the first and second insulating panels together.

19. The method according to claim 11, wherein the second, compressed thickness is about 20 to about 25 percent of the first, pre-compressed thickness.

20. The method according to claim 11, wherein the insulating panel portions are rectangular.
